(19) United States
(12) Patent Application Publication
(10) Pub. No.: US 2023/0403219 A1
(43) Pub. Date: Dec. 14, 2023

(54) HIGH SPEED DATA PACKET PCAP CAPTURE AND STORAGE WITH ERROR DETECTION-CORRECTION

(71) Applicant: Stephen W. Harting, Cupertino, CA (US)

(72) Inventor: Stephen W. Harting, Cupertino, CA (US)

(21) Appl. No.: 17/838,788

(22) Filed: Jun. 13, 2022

(51) Int. Cl. H04L 43/0823; H04L 43/0817; H04L 43/50; H04L 67/1097

(52) U.S. Cl. CPC H04L 43/0823; H04L 43/0817; H04L 43/50; H04L 67/1097

(57) ABSTRACT

Described are systems and methods supporting a PHY network interface unit configured to extract bytes from an analog interface, where a MAC unit is coupled to the PHY unit and arranged to receive bytes into packets and further process packets into blocks. An embodiment may involve Markers where Marker(n) contains (i) sequence number=n, (ii) timestamp of the creation time of the Marker(n), (iii) LBA and offset into the LBA of the first byte of first packet within the associated Marker. (iv) sufficient space for per-packet P4 Table (match). The same or a different processor may instruct a controller to write Markers to a non-volatile memory unit. Error detection and correction can be achieved by utilizing Markers to re-construct corrupted PCAP files. As noted above, packet capture on conventional computing devices is limited due to these devices not being optimized for processing a PCAP file that experiences corruption.

### CROSS-REFERENCE TO RELATED APPLICATIONS

This patent application is related to and claims priority benefit under 35 U.S.C. § 119(e) to co-pending and commonly-owned U.S. Provisional Patent Application No. 63/195,584, entitled “HIGH SPEED DATA PACKET PCAP CAPTURE AND STORAGE WITH ERROR DETECTION-CORRECTION,” naming as inventor Stephan Harting, and filed Jun. 1, 2021, which patent document is incorporated by reference herein in its entirety and for all purposes.

### REFERENCES CITED

U.S. Patent Documents

| | | |
|---|---|---|
| 6134630 | October 2000 | McDonald |
| 6170063 | January 2001 | Golding |
| 6182176 | January 2001 | Ziegler |
| 6473809 | October 2002 | Aref |
| 8433777 | April 2013 | Liu |
| 8880696 | November 2014 | Michels |
| 2011/0225302 | September 2011 | Park |
| 2013/0145105 | June 2013 | Sawicki |
| 10831408 | November 2020 | Foo |

### OTHER PUBLICATIONS

Kim et al., High available system control network in the packet transport system, IEEE, Conference Paper, pp. 1-3 (Year: 2010), cited by examiner.
“Libpcap File Format,” The Wireshark Wiki, imported from https://wiki.wireshark.org/Development/LibpcapFileFormat with timestamp 2020-08-11 23:12:52 UTC; reference version 2015, 3 pages. cited by applicant.
“Manpage of TCPDUMP,” imported from http://tcpdump.org/manpages/tcpdump.1.html with timestamp 17 Jan. 2022; reference 2017 version, 20 pages. cited by applicant.
P4₁₆ Language Specification, “P4 Tables”, imported from https://p4.org/p4-spec/docs/P4-16-v1.2.1.pdf, with timestamp 2020-06-11; reference section 13.2, 9 pages. cited by applicant.

### TECHNICAL FIELD

The present disclosure relates generally to systems and methods for non-volatile packet storage memory units. More particularly, the present disclosure relates to systems and methods for high-speed data packet PCAP capture and storage with error detection-correction.

### BACKGROUND

Data packet capture has become an essential tool for the securing and debugging of networks and network protocols. A computing device may capture packets on a network by configuring its network interface to receive some or all packets traversing the segment of the network to which the network interface is connected. The computing device may store captured packets, and/or display a representation of their contents in real time. As just some examples, intrusion detection systems (IDS s), intrusion prevention systems (IPSs), and packet analyzers rely on accurate data packet capture.

### SUMMARY

Conventional data packet capture tools, such as Tcpdump and Wireshark, operate on general purpose computing devices (e.g., personal computers operating WINDOWS® or LINUX® operating systems). These tools provide mechanisms for capturing packets for storage or real-time display.

While processor speed, memory size, and network data rates have each grown significantly over the last 20 years, network data rate improvements have outpaced that of processor speed and memory size. As a result, it is challenging to provide reliable, low-loss data packet capture in a high speed network. For example, capturing all data packets on one of today's Ethernet links operating at a speed of 10 gigabits per second, 40 gigabits per second, or 100 gigabits per second is virtually impossible using a software-based implementation on generic computing devices. Captured packets may be dropped in the network interface as they await processing by the kernel (operating system) of a computing device, dropped in the kernel as they await processing by a packet capture application operating on the computing device, or dropped because the packet arrival rate exceeds the rate at which captured packets can be written to a file system (e.g., disk drive) of the computing device.

The embodiments herein involve a packet capture architecture that processes blocks of packets rather than individual packets. These blocks are processed in a pipelined fashion with ample buffering as they are transferred between a customized PHY, MAC, PCAP, PCI, HBA and long-term (non-volatile) packet storage. As a result of this specifically-design architecture, sustained capture rates of 100 gigabits per second may be achieved.

Accordingly, a first example embodiment may involve a plurality of non-volatile packet storage memory units and a non-volatile file system memory unit containing a file system. The first example embodiment may also involve a network interface unit based on field-programmable gate array technology, where the PHY, MAC, PCAP, PCI, HBA unit is configured to arrange sequentially-received packets into blocks, where each blocks contains a plurality of packets, and where the network interface unit is further configured to extract P4 Table matches and generate Marker(n) for each blocks without modifying the PCAP file.

These as well as other embodiments, aspects, advantages, and alternatives will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 is a simplified block diagram exemplifying a computing device and illustrating some of the components that could be included in such a computing device, according to some embodiments of the present disclosure.

FIG. 2 defines the structure of a sequence of Marker(n) and FIG. 3 defines the content of Marker(n) (108), according to some embodiments of the present disclosure.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a tangible computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “hardware” and “software” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

### I. Example Computing Device and Packet Capture Thereon

This section introduces a popular PCAP file format for storing captured packets. As noted above, packet capture on conventional computing devices is limited due to these devices not being optimized for processing a PCAP file that experiences corruption. This section reviews these devices for purposes of comparison, focusing on their bottlenecks.

### A. Example Computing Device

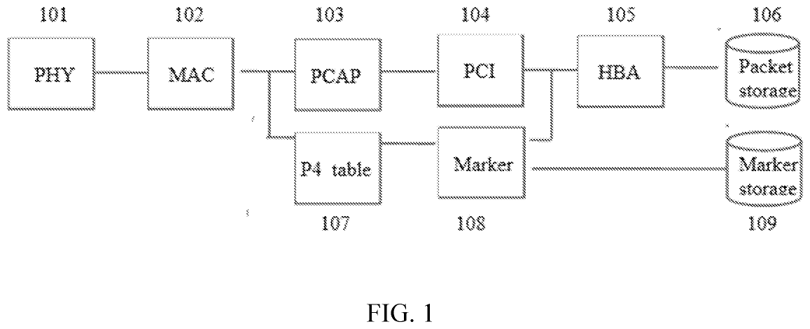

FIG. 1 is a simplified block diagram exemplifying a computing device and illustrating some of the components that could be included in such a computing device. The components illustrated by FIG. 1 may be carried out by one or more processors and memories coupled to a network interface and storage controller. The storage controller may, in turn, be coupled to long-term packet storage. The network interface may receive packets and arrange these packets into blocks.

The embodiments of FIG. 1 may be simplified by the removal of any one or more of the features shown therein. Further, these embodiments may be combined with features, aspects, and/or implementations of any of the previous figures or otherwise described herein.

PHY(101): PHYsical media device—input=analog signal, output=byte

FIG. 1 depicts connectivity between transceivers module PHY(101), Ethernet module MAC(102). Each transceiver in transceivers module PHY(101) may contain both a transmitter and a receiver that are combined and share common circuitry or a single housing. As noted previously, transceivers may be 10 gigabit per second, 40 gigabit per second, or 100 gigabit per second Ethernet transceivers.

MAC(102): Media Access Controller—input=bytes, output=packets(pkt)

Each of transceiver module PHY(101) may also be coupled to MAC(102) that performs Ethernet Medium Access Control (MAC). (Forward Error Correction (FEC), and Physical Coding Sublayer (PCS) functions not shown). Regardless, the flow of packets (and processing thereof) is generally from left to right.

IEEE 802.3 defines the Packet as beginning and end bits of an incoming Ethernet packet by detecting Ethernet preamble and epilogue delimiter bits. This sequence may be represented in hexadecimal as 0xFB 0x55 0x55 0x55 0x55 0x55 0x55 0xD5 (least-significant bit first ordering is used). The bit received immediately after this sequence may be the first of the Ethernet packet. Packet may also record a nanosecond timestamp of when the first byte of each packet was received from a high accuracy clock source. This timestamp may be adjusted for propagation delay by a fixed offset.

PCAP(103): industry standard file format for packet capture—input=packets, output=PCAP file

Header at the beginning of each packet. The contents of the header is the same as that of the PCAP per-packet header. A timestamp field that may contain the time (in nanoseconds) of when the packet was captured, a packet capture size field that may indicate the number of bytes of the packet that were actually captured, a packet wire size field that may indicate the actual size of the packet prior to capture. Other fields are possible, and more or less fields may be present. The packet capture size may be less than the packet wire size when P4 Tables is configured to reduce the size of captured packets.

PCI(104): Industry standard to communicate to storage Host Bus Adapters—input=PCAP files, output=Logical Block Address (LBA). PCI(104) may be implemented as a module.

The PCI(104) encapsulates PCAP files into LBA read/write commands to be interpreted by the module HBA(105). Additional formatting may be added to ensure that Marker(108) can readily identify the location of a particular PCAP packet withing a particular LBA. Marker(108) may be implemented as a module.

HBA(105): Host Bus Adapter—input=LBA and DATA, output=storage drive reads and writes

The module HBA(105) may conform to the ANSI T10/1562D specification for storage systems.

Capture write buffer temporarily stores blocks transferred from PCI. These blocks are then distributed across n units of non-volatile storage (106) (SSDO-SSDn). In order to do so, each blocks is queued for writing to one of these units. These entries are populated to spread consecutive blocks over the available units. While only 1 unit of non-volatile storage (106) (SSDs) are shown in FIG. 1 for purpose of convenience, more units may be used.

This arrangement provides for high-speed capture and storage of data packets. Particularly, sustained rates of 100 gigabytes per second can be supported. The end-to-end storage system described herein does so by operating on blocks rather than individual packets, carefully aligning blocks as well as packets within blocks for ease of processing. The process is similar to RAID0, where writing blocks sequentially across an array of SSDs (or other storage units) increases sequential write performance over writing sequentially to the same SSD, and prioritizing blocks writing operations over other operations.

Notably, when writing to a particular SSD, each blocks is written to a sequentially increasing location. This limits SSD stalls due to internal garbage collection and wear-leveling logic.

The Marker described in the next section is beneficial for both tcpdump.org and P4.org implementations. The preferred implementation is P4.org which is a super-set of the tcpdump.org capabilities.

### B. Example Enhanced Computing Device

P4 Tables(107): input=P4 Tables and pkt, output=match

P4 is an open source community packet classification standard. Its basic function is broken into two parts Table(match)=>Action. Only the Table(match) function is implemented for Packet classifier. P4 Tables classify each incoming packet based on pre-defined rules. The classification match includes binary (TRUE/FALSE) designations. The rules may include bit-wise logical “and” and “compare” operations on the first 250 bytes of the packet, for example. A total of 16 rules may be supported, and these rules may be software programmable. A packet may match multiple rules. Each rule match is preserved in the Module Marker for post-capture processing by external means.

Marker(108): Marker generator—input=match, LBA, Offset into LBA, output=marker file to storage

FIG. 3 Marker contents for Marker(n) include: (i) sequence number=n, (ii) timestamp of the creation time of the Marker(n), (iii) LBA and Offset into the LBA of the first byte of first packet within the associated Marker(n). (iv) sufficient space for per-packet P4 Table (match). (v) example Marker(n) capacity is 250 packet.

### C. Packet Capture

Given FIG. 1 and the operations performed by each of its modules, it is desirable for a packet capture architecture to be able to intercept and capture copies of incoming (received) packets.

P4 Tables(107) may provide a user interface through which one or more packet filter expressions may be entered. The user interface may include a graphical user interface, a command line, or a file.

The packet filter expressions may specify the packets that are to be delivered by P4 Tables. For example, the packet filter expression “host 10.0.0.2 and tcp” may capture all TCP packets to and from the computing device with the IP address 10.0.0.2. As additional examples, the packet filter expression “port 67 or port 68” may capture all Dynamic Host Configuration Protocol (DHCP) traffic, while the packet filter expression “not broadcast and not multicast” may capture only unicast traffic.

Packet filter expressions may include, as shown above, logical conjunctions such as “and”, “or”, and “not.” With these conjunctions, complex packet filters can be defined. Nonetheless, the packet filter expressions shown above are for purpose of example, and different packet filtering syntaxes may be used. For instance, some filters may include a bitstring and an offset, and may match any packet that includes the bitstring at the offset number of bytes into the packet.

### D. PCAP Packet Capture Format

Packet capture application may store the received packets in the industry standard PCAP (packet capture) format which consists of a PCAP header, followed by per-packet header: (i) Each instance of per-packet header may precede its associated packet. (ii) Captured packet length may specify the number of bytes of packet data actually captured and saved in file. (iii) Original packet length may specify the number of bytes in the packet as the packet appeared on the network on which it was captured.

### E. PCAP Packet Capture Corruption

The position of the next packet is calculated using the Captured packet length. A corruption of the Captured packet length creates catastrophic error propagation of all subsequent packets. Notably, Markers can be utilized for Error detection and correction and allow re-construction of corrupted PCAP files. In the next sections, PCAP and Marker Formats are disclosed.

### II. Example PCAP and Marker Formats and their Relationship

FPGA-based network interface FIG. 1 may be a custom hardware module that can house one or more 100 megabit per second, 1 gigabit per second, 10 gigabit per second, 25 gigabit per second, 40 gigabit per second, or 100 gigabit per second transceivers. FPGA-based network interface FIG. 1 may receive packets by way of these interfaces, and then capture and process these packets for storage. As suggested by its name, FPGA-based network interface FIG. 1 may be based on a field-programmable gate array or other digital hardware logic (i.e., an actual FPGA might not be used in all embodiments). Although Ethernet is used as the interface type for packet capture in the examples provided herein, other interface types may be possible.

Network management interface may be added onto one or more network interfaces used for connectivity and data transfer. For instance, while FPGA-based network interface FIG. 1 Marker(108) communicates to a separate storage device, such as non-volatile Marker storage unit (109), allowing a user to collect packet statistics, program the P4 Tables and remotely start or stop a packet capture session.

### A. Packet Capture PCAP Format

Packet capture application may store the received packets in one of several possible formats. The industry standard format is the PCAP (packet capture) format. There may be one instance of PCAP header followed by N+1 captured packets preceded by a per-packet header.

1) As noted above, PCAP header consists of:

Magic number serving to indicate the byte-ordering of the computing device that performed the capture. For instance, magic number may be defined to always have the hexadecimal value of 0xa1b2c3d4 in the native byte ordering of the capturing device. If magic number has a value of 0xd4c3b2a1, then this device may have to swap the byte-ordering of the fields that follow magic number.

Major version and minor version define the version of the PCAP format used. In most instances, major version is 2 and minor version is 4, which indicates that the version number is 2.4.

Time zone offset may specify the difference, in seconds, between the local time zone of the capturing device and Coordinated Universal Time (UTC). In some cases, the capturing device will set this field to 0 regardless of its local time zone.

Timestamp accuracy may specify the accuracy of any time stamps in file. In practice, this field is often set to 0.

Capture length may specify the maximum packet size, in bytes, that can be captured. In some embodiments, this value is set to 65536, but can be set to be smaller if the user is not interested in large-payload packets, for instance. If a packet larger than what is specified in this field is captured, it may be truncated to conform to the maximum packet size.

Datalink protocol may specify the type of datalink interface on which the capture took place. For instance, this field may have a value of 1 for Ethernet, 105 for Wifi, and so on.

2) As noted above, for PCAP per-packet header:

There may be one instance of per-packet header for each packet represented in file. Each instance of per-packet header may precede its associated packet. Timestamp seconds and timestamp microseconds may represent the time at which the associated packet was captured. As noted above, this may be the local time of the capturing device or UTC time.

Captured packet length may specify the number of bytes of packet data actually captured and saved in file.

Original packet length may specify the number of bytes in the packet as the packet appeared on the network on which it was captured.

Notably, A corruption of the Captured packet length creates catastrophic error propagation of all subsequent packets.

In general, Captured packet length is expected to be less than or equal to Original packet length. For example, if Capture length is 1000 bytes and a packet is 500 bytes, then Captured packet length and Original packet length may both be 500. However, if the packet is 1500 bytes, then Captured packet length may be 1000 while Original packet length may be 1500. While the traditional system described in the context of FIG. 1 may perform well in limited scenarios, it might not support high-speed packet capture in a robust fashion. For instance, modern Ethernet interface hardware support data rates of 10 gigabits per second, 40 gigabits per second, and 100 gigabits per second. Since traditional systems perform packet capture and filtering in software, the maximum speed of these systems is typically limited.

### B. Packet Capture Marker Format

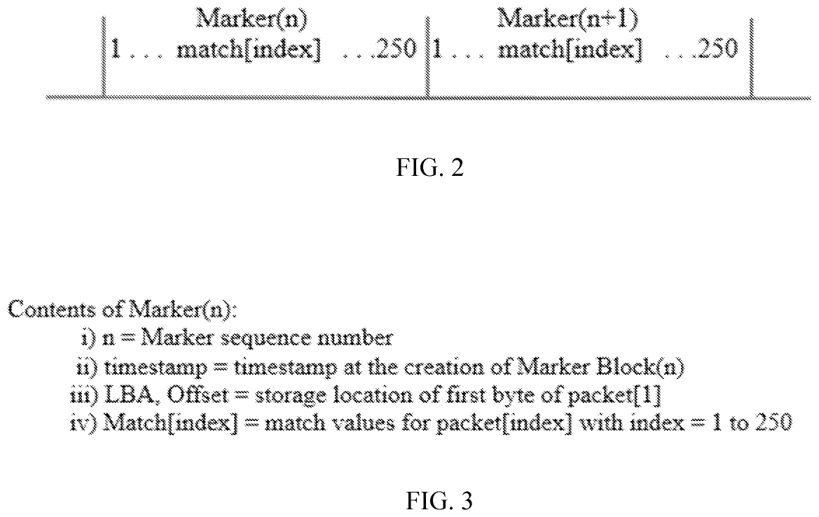

FIG. 2 and FIG. 3 Marker(n) (108) contents: (i) marker sequence number=n. (ii) timestamp of the creation time of the Marker(n), (iii) LBA and Offset into the LBA of the first byte of first packet within the associated Marker(n). (iv) Sufficient space for per-packet P4 Table matches. (v) Example Marker(n) capacity is 250 packets worth of Match(Item)s.

Marker (108) may involve receiving, from a network interface, packets. Marker creates a Block starting with (i) marker sequence number=n. (ii) timestamp of the creation time of the marker(n). (iii) LBA and Offset into the LBA of the first byte of first packet within the associated Marker(n). The Marker(n) may contain a plurality of per-packet P4 Table matches that were captured by the network interface. The network interface unit may include one or more Ethernet interfaces, each with a line speed of at least 10 gigabits per second.

In some embodiments, the size of each of the Marker(n) is fixed and identical. Each of the Markers may contain an integer number P4 Table Match(Item)s. The Markers may then be sent to non-volatile Marker storage unit (109) separate from Packet storage unit. Notably, Marker storage is less frequent that Packet storage and may be sent through the Management interface.

### C. Example Packet Capture and Marker P4 Table(Match) Numeric Relationships

FIG. 3 The PCAP(J) packet may be located within (Marker(n), Match(Item)) with the formula n=INT(J/250) and Item=remainder(J/250). The converse is also true, (Marker(n), Match(Item)) points to PCAP(n*250+Item) packet.

Notably, the relationships as noted above supports P4 Table verification at the packet level and that P4.org has a separate specification just for P4 Table verification.

In the next sections, error detection and correction is proposed and implemented.

### IV. Example Packet Capture System—Error Correction

Detection of PCAP corruption may be achieved when the last packet pointed to in Marker(n) does not end at the first byte of the first packet of Marker(n+1) i.e. LBA(n+1)+Offset(n+1).

Notably, Detection may span many Markers for example Marker(n) to Marker(n+x)

### IV. Example Packet Capture System—Error Correction

A. Correction may be achieved by discarding the entire contents of data pointed to by Marker(n) and beginning a new PCAP at first packet pointed to by Marker(n+1) i.e. LBA(n+1)+Offset(n+1).

B. Other more aggressive Correction policies are possible and may be implemented using Markers such as Forward Correction and Reverse Correction: 1) forward PCAP error correction process checks each packet starting at Marker(n) location attempting to recover packets forward up to the corrupted packet, 2) reverse PCAP error correction process checks each packet starting at Marker(n+1) location attempting to recover packets backwards down to the corrupted packet in Marker(n).

Notably, finding Marker(n) is aided by the timestamp embedded in the Markers.

### V. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively, or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a plurality of non-volatile packet storage memory units;
a non-volatile file system memory unit containing a file system;
a PHY network interface unit configured to extract bytes from an analog interface;
a MAC unit coupled to the PHY network interface unit and arranged to receive bytes into packets and further process packets into blocks where each of the blocks contains a plurality of packets;
a P4 unit coupled to the MAC unit and configures to create P4 Table matches of the received packets;
a Marker unit coupled to the P4 unit and configured to generate Marker(n) for each n, the Marker(n) respectively containing one or more timestamps and per-packet matches within an associated Marker(n) with their LBA storage address;
the file system coupled to the Marker unit to accept the Marker(n) writes separate from packet storage system; and
a PCAP unit coupled to the MAC unit, wherein PCAP file format is created; wherein PCI unit is coupled to PCAP unit to create ANSI T10 LBA storage commands, wherein HBA unit is coupled to PCI unit converting LBA into Read/write commands to a packet storage system.

2. The system of claim 1, wherein the P4 unit executes P4 Table matches.

3. The system of claim 1, wherein a size of each of the Marker(n) is fixed and identical.

4. The system of claim 1, wherein each of the Marker(n) contains i) block number, ii) Timestamp, iii) location in storage of a first byte of first packet after Marker creation and iv) integer number of P4 Table matches.

5. The system of claim 1, wherein each of the Marker(n) is written to the file system.

6. The system of claim 1, wherein PCAP error detection process compares Marker(n) location with Marker(n+1) location to assess if packets are corrupted.

7. The system of claim 1, wherein PCAP error correction process removes PCAP data starting at Marker(n) location to Marker(n+1) location thereby restoring a remainder of PCAP file.

8. The system of claim 1, wherein forward PCAP error correction process checks each packet starting at Marker(n) location attempting to recover packets forward up to a corrupted packet.

9. The system of claim 1, wherein reverse PCAP error correction process checks each packet starting at Marker(n+1) location attempting to recover packets backwards down to a corrupted packet.

10. The system of claim 1, wherein packet identification and extraction creates a new PCAP file utilizing packets identified by Marker match.

11. The system of claim 1, wherein packet identification and extraction include per packet AND, OR, NOT combinations of a multitude of Marker matches.

12. The system of claim 1, wherein packet identification and extraction may be used to verify P4 Table compliance without an expense of purchasing P4 compliant hardware.

13. The system of claim 1, wherein packet identification and extraction may be used to verify that a network benefits from purchasing P4 compliant hardware.

14. A method comprising:
operating a plurality of non-volatile packet storage memory units;
extracting bytes from an analog interface by a PHY network interface unit;
arranging to receive bytes into packets and further process packets into blocks by a MAC unit coupled to the PHY network interface unit, where each of the blocks contains a plurality of packets;
creating P4 Table matches of the received packets by a P4 unit coupled to the MAC unit;
generating Marker(n) for each n, by a Marker unit coupled to the P4 unit, the Marker(n) respectively containing one or more timestamps and per-packet matches within an associated Marker(n) with their LBA storage address; and
creating a PCAP file format by a PCAP unit coupled to the MAC unit, wherein PCI unit is coupled to PCAP unit to create ANSI T10 LBA storage commands, wherein HBA unit is coupled to PCI unit converting LBA into Read/write commands to a packet storage system,
wherein, a non-volatile file system memory unit comprises a file system and wherein the file system, coupled to the Marker unit to accept the Marker(n), writes separate from packet storage system.

15. The method of claim 14, wherein PCAP error correction process removes PCAP data starting at Marker(n) location to Marker(n+1) location thereby restoring a remainder of PCAP file.

16. The method of claim 14, wherein reverse PCAP error correction process checks each packet starting at Marker(n+1) location attempting to recover packets backwards down to a corrupted packet.

17. The method of claim 14, wherein forward PCAP error correction process checks each packet starting at Marker(n) location attempting to recover packets forward up to a corrupted packet.

18. The method of claim 14, wherein packet identification and extraction creates a new PCAP file utilizing packets identified by Marker match.

19. The method of claim 14, wherein packet identification and extraction include per packet AND, OR, NOT combinations of a multitude of Marker matches.

20. A non-transitory computer readable storage medium having computer program code stored thereon, the computer program code, when executed by a computing device, causes the computing device to perform a method comprising:
operating a plurality of non-volatile packet storage memory units;
extracting bytes from an analog interface by a PHY network interface unit;
arranging to receive bytes into packets and further process packets into blocks by a MAC unit coupled to the PHY network interface unit, where each of the blocks contains a plurality of packets;
creating P4 Table matches of the received packets by a P4 unit coupled to the MAC unit;
generating Marker(n) for each n, by a Marker unit coupled to the P4 unit, the Marker(n) respectively containing one or more timestamps and per-packet matches within an associated Marker(n) with their LBA storage address; and
creating a PCAP file format by a PCAP unit coupled to the MAC unit, wherein PCI unit is coupled to PCAP unit to create ANSI T10 LBA storage commands, wherein HBA unit is coupled to PCI unit converting LBA into Read/write commands to a packet storage system,
wherein, a non-volatile file system memory unit comprises a file system and wherein the file system, coupled to the Marker unit to accept Marker(n), writes separate from packet storage system.
